(19) United States
(12) Patent Application Publication
(10) Pub. No.: US 2017/0170642 A1
(43) Pub. Date: Jun. 15, 2017

(54) SHEAVE PROFILE

(71) Applicant: Sherman + Reilly, Inc., Chattanooga, TN (US)

(72) Inventors: Matthew Caleb Faircloth, Wildwood, GA (US); William Kyle Godsey, Huntsville, AL (US)

(21) Appl. No.: 15/370,517

(22) Filed: Dec. 6, 2016

Related U.S. Application Data
(60) Provisional application No. 62/265,131, filed on Dec. 9, 2015.

(51) Int. Cl. H02G 7/00; H02G 3/04

(52) U.S. Cl. CPC H02G 7/00; H02G 3/0437; H02G 3/0406

(57) ABSTRACT

A sheave is configured to be mounted on an electrical stringing block and is configured to hold a conductor therein. The sheave includes a groove formed continuously along an outer surface of a circular body. The groove has a profile which is optimized to support the conductor, such that the conductor is prevented from riding out of the profile upon rotation of the sheave. The profile includes a radial section defining a pair of tangents and a pair of flared sections extending along the respective tangents from outer ends of the radial section. Each flared section extends outwardly at an angle relative to a centerline of the body. The radial section has a radius which is approximately the same as the radius of the conductor. The profile defines a depth which is scaled with the diameter of the conductor, such that the conductor does not extend outwardly from the groove.

This application claims the domestic priority of United States Provisional Application Serial No. 62/265,131, filed on Dec. 9, 2015, the contents of which are incorporated herein in its entirety.

### FIELD OF THE DISCLOSURE

The present disclosure generally relates to the field of power transmission and distribution, and specifically relates to the profile of a sheave, such sheave being configured for use in an electrical stringing block for conductor installation of overhead electrical transmission and distribution lines or any other aerial cables installation. In an embodiment, the sheave is optimized for use with T-2 conductor.

### BACKGROUND

High-tension wires are strung from a power source through a series of electrical suspension towers and telephone poles in order to transfer power from the source to the consumer. Electrical stringing blocks are installed on towers and poles to pull transmission and distribution conductor thru the blocks. A lead rope is strung through the electrical stringing blocks, either manually or by a helicopter. Then, the lead rope is exchanged by single, bundled, or twisted conductor forming the wire, running in the electrical stringing blocks. Finally, the wire is transferred from the electrical stringing blocks to clamps for long term energizing

Standard construction for an electrical stringing block include cast aluminum sheaves or molded nylon sheaves, supported by bearings on a solid axle, suspended in a cast or fabricated metal frame. The sheaves have a plurality of spokes, which are optimized for casting. Sheaves can also be comprised of a solid body or plates that do not have spokes.

During use, T-2 conductor rotates in a helical manner as the conductor progresses down the line. It is desirable to prevent the T-2 conductor from unintentionally exiting the sheave during use.

### SUMMARY

A sheave in accordance with some example embodiments is configured to be mounted on an electrical stringing block and is configured to hold a conductor therein. The sheave includes a groove formed continuously along an outer surface of a circular body. The groove has a profile which is optimized to support the conductor, such that the conductor is prevented from riding out of the profile and such that the conductor does not “bounce” on the groove upon rotation of the sheave relative to the electrical stringing block. The profile includes a radial section defining a pair of tangents and a pair of flared sections extending along the respective tangents from outer ends of the radial section. Each flared section extends outwardly at an angle relative to a centerline of the body. The radial section has a radius which is approximately the same as the radius of the conductor. The profile defines a depth which is scaled with the diameter of the conductor, such that the conductor does not extend outwardly from the groove.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 is a side elevation view of a sheave which may form part of an electrical stringing block;

FIG. 2 is a cross-sectional view of the sheave along line 2-2 of FIG. 1;

FIG. 3 is an enlargement of the circle shown in FIG. 2, and showing a conductor seated thereon;

FIG. 4 is a cross-sectional view of a prior art conductor configured for use with the sheave; and

FIG. 5 is a partial cross-sectional view of the sheave having the conductor of FIG. 4 seated therein.

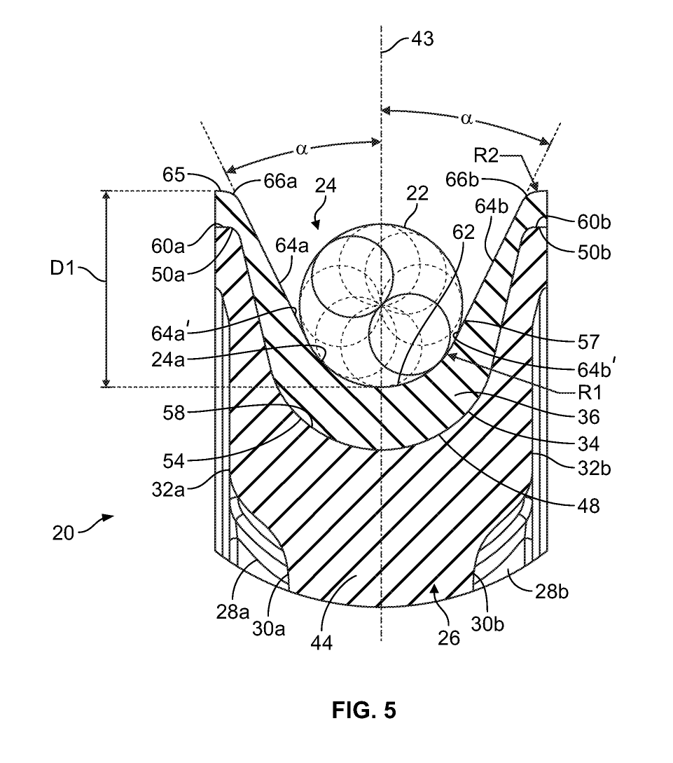

### DETAILED DESCRIPTION

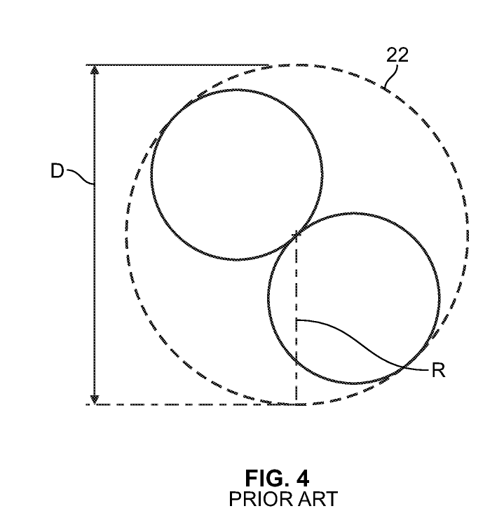

A sheave 20 configured to be rotationally mounted to an electrical stringing block (not shown) is disclosed. The electrical stringing block is used to route a conductor 22 to provide power from a source to a consumer. In an embodiment, the sheave 20 is optimized for use with a twisted pair conductor, such as a T-2 conductor which is an aluminum strand, steel reinforced twisted pair conductor. As shown in FIG. 4, the conductor 22 has a radius R and a diameter D which are shown in reference to the dotted line circle which defines an imaginary circle that shows the effective diameter of the twisted pair conductor. For example, one embodiment of a T-2 conductor has a radius R of about 1.108″ and a diameter D of about 2.216″.

The sheave 20 has a groove 24 provided therein in which the conductor 22 seats. The design of the groove 24 allows the conductor 22 to rotate uniformly through the sheave 20 such that the conductor 22 maintains contact with a bottom 24a of the groove 24. The groove 24 has a profile 57 which is optimized to support the conductor 22, such that the conductor 22 is prevented from riding out of the profile 57. By not “riding out” of the profile 57, this means that the conductor 22 remains seated within the profile 57 during use. As such, the conductor 22 does not “bounce” (e.g. move on and off of) on the bottom 24a of the groove 24 upon rotation of the sheave 20.

The electrical stringing block is formed from at least one sheave 20 mounted on a metal tubular axle (not shown) by at least one bearing (not shown), and support arms (not shown) extending through the axle. The support arms are used to mount the electrical stringing block to the tower. In an embodiment, a single sheave 20 is provided as part of the electrical stringing block. In an embodiment, two sheaves 20 are provided as part of the electrical stringing block. In an embodiment, three or more sheaves 20 are provided as part of the electrical stringing block. When more than one sheave 20 is provided, a bundle block is formed. The electrical stringing block may be mounted on a high tower (not shown).

The sheave 20 is formed of a solid body 26 having opposite sides 32a, 32b and which defines an outer circular circumference. The body 26 has an inner wall 40 forming a central passageway 42 therethrough which extends between the sides 32a, 32b of the body 26. The passageway 42 defines a first centerline 42a of the body 26. A second centerline 43 of the body 26 is defined transverse to the first centerline 42a. The axle extends through the central passageway 42 and the bearings seat between the axle and the inner wall 40. The body 26 has a recess 34 on its outer circumference in which a lining 36 is provided. The lining 36 forms the groove 24 into which the conductor 22 seats during the stringing process. The lining 36 is continuous around the circumference of the body 26.

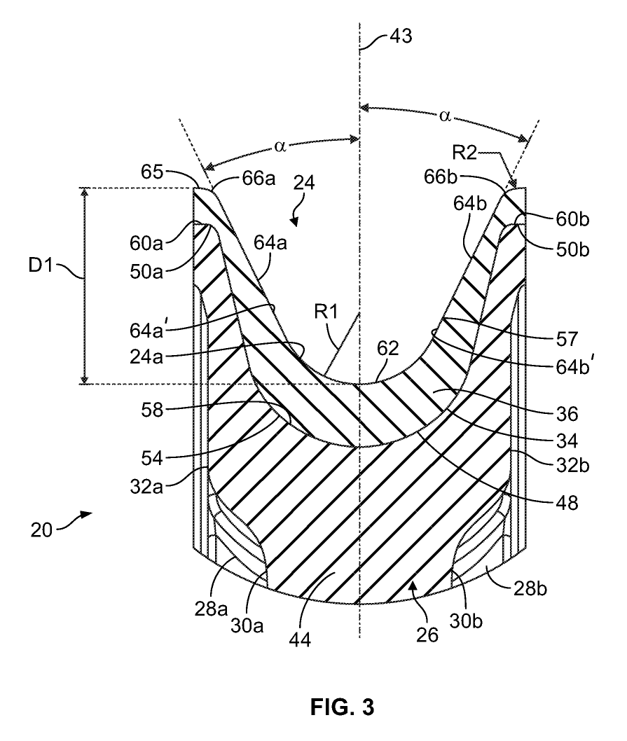

As shown in the cross-sectional view of FIG. 3, in an embodiment, the recess 34 includes a curved surface 48 which is generally U-shaped, and outer end surfaces 50a, 50b which extend from the opposite outer ends of the curved inner section 48. In an embodiment, the outer end surfaces 50a, 50b are planar and are parallel to the first centerline 42a. In an embodiment, the outer end surfaces 50a, 50b are radial as shown. In an embodiment, the cross-section of the recess 34 is continuous around the circumference of the sheave 20.

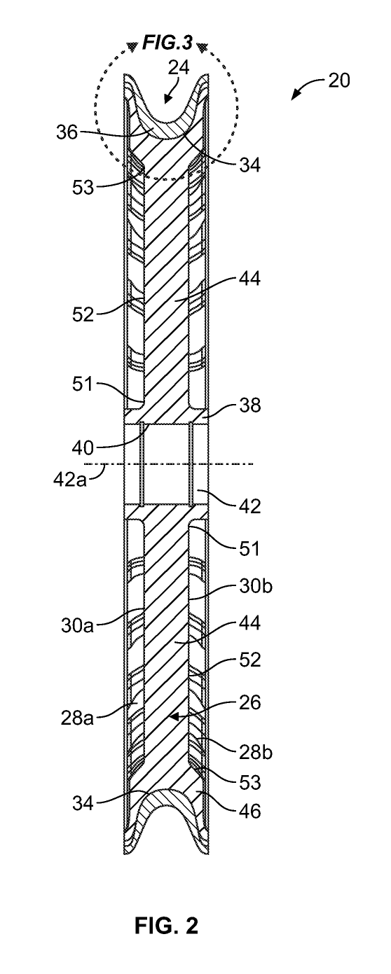

The lining 36 is provided in the recess 34 and in an embodiment has an inner surface 54 which mirrors the shape of the surfaces 48, 50a, 50b of the recess 34. In an embodiment as shown in the cross-sectional view of FIGS. 2 and 3, the inner surface 54 of the lining 36 has a curved surface 58 which is generally U-shaped, and outer end surfaces 60a, 60b which extend from the opposite outer ends of the curved surface 58. Depending upon the shape of the surfaces 50a, 50b, in an embodiment, the outer end surfaces 60a, 60b are planar and are parallel to the first centerline 42a; in an embodiment, the outer end surfaces 50a, 50b are radial. This cross-section of the inner surface 54 of the lining 36 is continuous around the circumference of the sheave 20.

The lining 36 has an outer surface 56 which forms the profile 57 of the groove 24 for holding the conductor 22 as described herein. In an embodiment, the profile 57 is generally U-shaped. The profile 57 of the groove 24 is optimized to support the conductor 22, such that the conductor 22 is prevented from riding out of the groove 24 and prevented from bouncing on the bottom 24a of the groove 24. As shown in the cross-sectional view of FIG. 3, the outer surface 56 of the lining 36 has a central radial section 62 and a pair of flared sections 64a, 64b; respective flared sections 64a, 64b extending from the outer ends of the radial section 62 and extending outwardly at an angle from the centerline 24a. The radial section 62 is defined by a radius R1 which is approximately the same as the radius R of the conductor 22. Each flared section 64a, 64b extends along the tangent defined by the radial section 62, and the flared sections 64a, 64b are angled relative to each other. The bottom 24a of the groove 24 is defined by the radial section 62 and a lower part 64a′, 64b′ of each flared section 64a, 64b. The outer ends of the flared sections 64a, 64b define outermost surfaces 65 of the profile 57. This cross-section of the outer surface 56 of the lining 36 is continuous around the circumference of the sheave 20.

In an embodiment, the lining 36 is formed of non-conductive material, such as urethane or polyurethane. In an embodiment, the lining 36 is overmolded onto the recess 34. In an embodiment, the lining 36 is overmolded onto the curved surface 48 and to the outer end surfaces 50a, 50b which in an embodiment form the recess 34. In an embodiment, the lining 36 is formed in a cast molding process. In an embodiment, the lining 36 is formed by an extruded or injection molded resin. In an embodiment, the lining 36 is separately formed and wrapped onto the recess 34. Other materials and processes for forming the lining 36 are within the scope of the present disclosure.

The profile 57 defines a depth D1 which is measured along the second centerline 43 and extends between the outermost surfaces 65 of the lining 36 and the innermost point of the radial section 62 as shown in FIG. 3. The depth D1 is scaled (e.g., proportionally scaled) with the diameter D of the conductor 22 to ensure that the conductor 22 is completely sunk within the profile 57, that is, the conductor 22 does not extend outwardly from the outermost surfaces 65 of the groove 24. The scaling of the depth D1 with the diameter D of the conductor 22 is a minimum ratio; the depth D1 may have a greater depth than the diameter D of the conductor 22.

In an embodiment as shown in the cross-sectional view of FIG. 3, the outermost surfaces 65 of the profile 57 are formed of outer edge sections 66a, 66b, each of which extends from the outer end of the respective flared sections 64a, 64b. In an embodiment, the outer edge sections 66a, 66b are radial as shown. In an embodiment, the outer edge sections 66a, 66b are formed as a chamfer, and the like, to promote the entry of the conductor 22 into the groove 24. Radial, chamfered, etc. outer edge sections 66a, 66b are not necessary. In an embodiment, the outer edge sections 66a, 66b are formed as corners.

While the sheave 20 is described as having a body 26 and a lining 36, the lining 36 may be eliminated and the recess 34 is formed as the groove 24. Thus, in this embodiment, the profile 57 is formed as part of the body 26. In this embodiment, the body 26 may be formed of non-conductive materials.

In FIG. 3, the two circles shown in full line depict the conductors of the conductor 22, while the circles shown in dotted line depict the variations of the conductors spinning when the conductor 22 rotates uniformly through the sheave 20.

In an embodiment, it has been found that the dimensions of groove 24 configured for use with the T-2 conductor (an aluminum strand, steel reinforced twisted pair conductor, having a radius R of about 1.108″) may be:

1) The radial section 62 has a radius R1 of about 1.108″ which is optimized to support the diameter D of the T-2 conductor.

2) Each flared section 64a, 64b extends at an angle a between 23 degrees and 30 degrees from the second centerline 43 of the sheave 20, and preferably at an angle a of 26 degrees. As such, the included angle between the flared sections 64a, 64b is between 46 degrees and 60 degrees, and is preferably 52 degrees.

3) The depth D1 of the groove 24 is about 2.68″.

The depth D1 may be greater than about 2.68″.

In an embodiment, the outer edge sections 66a, 66b are radial and have a radius R2 of about 0.25″, but this is exemplary.

Larger/smaller size conductors, e.g. having a radius R of greater or lesser than about 1.108″, may also be used with the profile 57. With different size conductors, the profile 57 is scaled accordingly, depending on the size of the conductor. The scaled profile maintains the same properties as current profile.

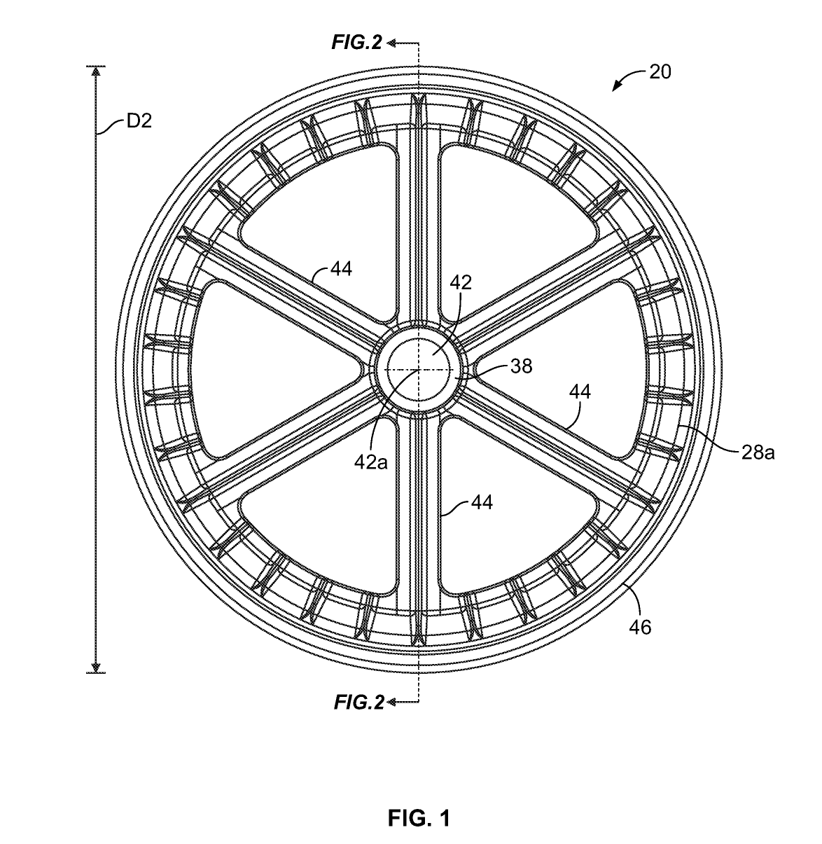

In an embodiment, the body 26 has a diameter D2, see FIG. 1, of about 42.5″. In an embodiment, the body 26 has other diameters D2 which are greater than or less than about 42.5″.

In an embodiment, the body 26 is formed from a central hub 38 which forms the inner wall 40, a plurality of spokes 44 extending radially outwardly from the central hub 38, and an outer ring 46 at the outer ends of the spokes 44. The outer ring 46 extends continuously around the circumference of the body 26. Each spoke 44 has an inner end connected to the hub 38 and an outer end connected to an inner surface of the outer ring 46. The recess 34 is provided in the outer surface of the outer ring 46 and extends around the circumference of the outer ring 46. In an embodiment, the body 26 includes a pair of recesses 30a, 30b formed in the side surfaces 32a, 32b of the body 26. Each recess 30a, 30b has an inner portion 51 which is provided in at least part of the sides of the central hub 38 and extends continuously around the inner hub 38, an intermediate portion 52 which extends along the sides of the spokes 44, and an outer portion 53 which is provided in at least part of the sides of the outer ring 46 and extends continuously around the outer ring 46. In an embodiment, separate side walls 28a, 28b seat within the recesses 30a, 30b. In an embodiment, the shapes of the side walls 28a, 28b mirror the shapes of the recesses 30a, 30b. In an embodiment, each side wall 28a, 28b is formed of metal, such as aluminum, to be robust. In an embodiment, the outer side surfaces of the side walls 28a, 28b are flush with the side surfaces 32a, 32b of the body 26. These side walls 28a, 28b aid in maintaining the circular shape of the outer ring 46. In an embodiment, the side walls 28a, 28b and recesses 30a, 30b are eliminated. In an embodiment, the spokes 44 are eliminated and instead the body 26 is a solid body or plate that does not have spokes. With this embodiment, the recess 34 is provided in the outer surface of the body 26 or in the lining 36 on the body 26

In use, the conductor 22 rests in the groove 24 such that the conductor 22 seats against the bottom 24a of the groove 24. The conductor 22 rotates in a helical manner as the conductor 22 passes through the groove 24. The angle a of the flared sections 64a, 64b and the depth D1 of the groove 24 maintain the seating of the conductor 22 in the bottom 24a of the groove 24. The sheave 20 rotates on the bearings surrounding the axle.

Many modifications and other embodiments of the disclosure set forth herein will come to mind to one skilled in the art to which these disclosed embodiments pertain having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

What is claimed is:

1. A sheave configured to be mounted on an electrical stringing block and configured to hold a conductor therein, the conductor defining a diameter, the sheave comprising:
a body having opposite sides and forming an outer circular circumference, the body including a central passageway extending between the opposite sides, a first centerline of the body is defined through the central passageway, a second centerline of the body is defined transverse to the first centerline, and a continuous groove is provided in the outer circular circumference of the body,
the groove forming a profile configured to hold the conductor therein, the profile comprising a radial section defining a pair of tangents and a pair of flared sections extending along the respective tangents from outer ends of the radial section, each flared section extending outwardly at an angle relative to the first centerline, each flared section defining an outermost surfaces of the profile, the radial section being defined by a radius which is approximately the same as the radius of the conductor seated therein,
wherein the profile defines a depth extending along the second centerline and extending between the outermost surfaces to an innermost point of the radial section, the depth being scaled with the diameter of the conductor such that the conductor does not extend outwardly from the outermost surfaces of the profile.

2. The sheave of claim 1, wherein the depth is greater than the diameter of the conductor.

3. The sheave of claim 1, wherein a separate lining is mounted on the body, the groove being formed in the lining.

4. The sheave of claim 1, wherein the lining is formed of non-conductive material.

5. The sheave of claim 4, wherein the lining is formed of one of urethane and polyurethane

6. The sheave of claim 1, wherein the radial section has a radius of about 1.108″.

7. The sheave of claim 1, wherein the radial section has a radius which is greater than about 1.108″.

8. The sheave of claim 1, wherein each flared section extends at an angle between 23 degrees and 30 degrees from the second centerline.

9. The sheave of claim 1, wherein the depth of the profile is about 2.68″.

10. The sheave of claim 1, wherein the outermost surfaces are radial.

11. The sheave of claim 10, wherein the outermost surfaces are comprised of a radius of about 0.25″.

12. The sheave of claim 1, wherein the body has a diameter of about 42.5″.

13. The sheave of claim 1, wherein the body further includes a recess in each side, and further including a separate metal side wall mounted in each recess.

14. The sheave of claim 1, wherein the body includes a central hub having an inner wall forming the central passageway therethrough, a plurality of spokes extending radially outwardly from the central hub, and an outer ring at outer ends of the spokes, the outer ring extending continuously around the circumference of the body, the recess being provided in an outer surface of the outer ring and extending continuously around the circumference of the outer ring.

15. A combination comprising:
a conductor defining a diameter;
a sheave configured to be mounted on an electrical stringing block and comprising
a body having opposite sides and forming an outer circular circumference, the body including a central passageway extending between the opposite sides, a first centerline of the body is defined through the central passageway, a second centerline of the body is defined transverse to the first centerline, and a continuous groove is provided in the outer circular circumference of the body,
the groove forming a profile configured to hold the conductor therein, the profile comprising a radial section defining a pair of tangents and a pair of flared sections extending along the respective tangents from outer ends of the radial section, each flared section extending outwardly at an angle relative to the first centerline, each flared section defining an outermost surfaces of the profile, the radial section being defined by a radius which is approximately the same as the radius of the conductor seated therein,
wherein the profile defines a depth extending along the second centerline and extending between the outermost surfaces to an innermost point of the radial section, the depth being scaled with the diameter of the conductor such that the conductor does not extend outwardly from the outermost surfaces of the profile.

16. The combination of claim 15, wherein the depth is greater than the diameter of the conductor.

17. The combination of claim 15, wherein a separate non-conductive lining is mounted on the body, the groove being formed in the lining.

18. The combination of claim 15, wherein the conductor has a radius less than about 1.108″.

19. The combination of claim 15, wherein the conductor has a radius greater than about 1.108″.

20. The combination of claim 15, wherein each flared section extends at an angle between 23 degrees and 30 degrees from the second centerline.
